(19) United States
(12) Patent Application Publication
(10) Pub. No.: US 2013/0088827 A1
(43) Pub. Date: Apr. 11, 2013

(54) Multi-Purpose Display Platform

(71) Applicant: FRONTIER ELECTRONIC SYSTEMS CORP., Stilwater, OK (US)

(72) Inventors: Shawn Michael Standfast, Perkins, OK (US); Aleksander Sequoya Wolfe, Stillwater, OK (US); Kevin Peter Koskela, Stillwater, OK (US)

(73) Assignee: FRONTIER ELECTRONIC SYSTEMS CORP., Stillwater, OK (US)

(21) Appl. No.: 13/647,270

(22) Filed: Oct. 8, 2012

Related U.S. Application Data
(60) Provisional application No. 61/545,098, filed on Oct. 7, 2011.

(51) Int. Cl. G06F 1/16

(52) U.S. Cl. 361/679.21

(57) ABSTRACT

The embodiments of the invention, a low-cost display system (MDP), consists of an operating system software, electronic circuit cards, a display module, a ruggedized housing, a control bezel, and interface connectors that can be utilized as a platform for hosting application-specific software. The application-specific software would be developed to cause the MDP to fulfill display requirements that are specific to the weapons system, vehicle or other platform into which it is to be installed. This technical approach is analogous to the iPhone (representing the MDP) and its apps (representing the application-specific software).

The electronic hardware and software designs contain “hooks” that allow for the expansion of current functionality and the addition of new functionality without significant design/engineering effort. This allows customization of the MDP to meet the needs of multiple applications while maintaining a low cost.

### CROSS-REFERENCE TO RELATED APPLICATIONS

This application claims priority of U.S. Provisional Patent Application with Ser. No. 61/545,098 of the same title filed on Oct. 7, 2011. The entire contents of U.S. Provisional Patent Application with Ser. No. 61/545,098 are herein incorporated by reference.

### STATEMENT REGARDING FEDERALLY SPONSORED RESEARCH OR DEVELOPMENT

Not applicable

### FIELD OF THE EMBODIMENTS

The field of the embodiments is display systems.

### SUMMARY OF THE EMBODIMENTS

In summary, the embodiments of the invention, a low-cost display system known as the

Multi-Purpose Display Platform (MDP), consists of operating system software, electronic circuit cards, a display module, a ruggedized housing, a control bezel, and interface connectors that can be utilized as a platform for hosting application-specific software. Because of the various elements of the embodiments, including the built-in test, the rugged structure of the embodiments, and application-specific software, the MDP embodiments can be employed in a wide range of applications including, without limitation, weapons systems, vehicle mounted systems, or other platforms requiring an adaptable ruggedized platform. This technical approach is analogous to the iPhone (representing the MDP) and its apps (representing the application-specific software).

The electronic hardware and software designs contain “hooks” that allow for the expansion of current functionality and the addition of new functionality without significant design/engineering effort. This allows customization of the MDP to meet the needs of multiple applications while maintaining a low cost.

In this respect, it is to be understood that the embodiments in this application are not limited to the details of construction and to the arrangements of the components set forth in the description or illustrated in the drawings. The embodiments are capable of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the embodiments described in this application. Additional benefits and advantages of the present embodiments will become apparent in those skilled in the art to which the embodiments relate from the description of the preferred embodiment and the appended claims, taken in conjunction with the accompanying drawings. It is important, therefore, that the claims be regarded as including such equivalent constructions insofar as they do not depart from the spirit and scope of the embodiments described herein.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the embodiments of the application, which is measured by the claims, nor is it intended to be limiting as to the scope of the embodiments in any way.

### BRIEF DESCRIPTIONS OF THE DRAWINGS OF THE EMBODIMENTS

FIG. 1 is a functional block schematic showing the Core Configuration of the embodiments.

FIG. 2 is an exploded view schematic of the embodiments showing the card cage structure with the power supply 110, video interface (PSVI) board 113, and processor board 112 mounted in an I-beam structure.

FIG. 3 is a photograph of a prototype unit of the core configuration of the embodiments.

FIG. 4 is a table showing the estimated power budget of the embodiments.

FIG. 5 is a functional block schematic showing the electrical design of the PSVI board.

FIG. 6 is a functional block schematic showing the electrical design of the processor board 112.

FIG. 7 is a functional block schematic showing the software components of the core configuration and their role in the hardware initialization of the embodiments.

FIG. 8 is a functional block schematic showing the expansion capability of the embodiments.

### DETAILED DESCRIPTION OF THE PREFERRED EMBODIMENTS

The embodiments of the invention, a low-cost display system (MDP), consist of operating system software 100, electronic circuit cards 101, a display module 102, a ruggedized housing 103, a control bezel 104, and interface connectors 106 that can be utilized as a platform for hosting application-specific software. The application-specific software has been developed to cause the MDP to fulfill display requirements that are specific to the weapons system, vehicle or other platform into which it is to be installed. This technical approach is analogous to the iPhone (representing the MDP) and its apps (representing the application-specific software).

The acronym “3ATI” means Air Transport Industry Chassis Size 3.

The acronym “ADC” means Analog to Digital Converter.

The acronym “API” means Application Program Interface.

The acronym “ARINC” means Aeronautical Radio Incorporated.

The acronym “BIT” means Built In Test.

The acronym “BT656” means ITU-R Recommendation BT.656.

The acronym “CCA” means Circuit Card Assembly.

The acronym “CCD” means Charge Coupled Device.

The acronym “CMOS means Complimentary Metal Oxide Silicone.

The acronym “COTS” means Common Off-The-Shelf.

The acronym “DDR2” means Dual Data Rate 2.

The acronym “DSP” means Digital Signal Processing.

The acronym “EMAC” means Ethernet Media Access Control.

The acronym “EMIF” means External Memory Interface.

The acronym “I2C” means Inter-Integrated Circuit.

The acronym “I/O” means Input/Output.

The acronym “LVPS” means Low Voltage Power Supply.

The acronym “MDIO” means Management Data Input Output.

The acronym “MDP” means Multi-Purpose Display Platform.

The acronym “NTSC” means National Television System Committee.

The acronym “ODA” means Optical Display Assembly.

The acronym “OFP” means Operational Flight Program.

The acronym “PAL” means Phase Alternating Line.

The acronym “PROM” means Programmable Read Only Memory.

The acronym “PSVI” means Power Supply and Video Interface.

The acronym “RAM” means Random Access Memory.

The acronym “ROM” means Read Only Memory.

The acronym “RGB” means Red Green Blue.

The acronym “RTOS” means Real Time Operating System.

The acronym “SPI” means Serial Peripheral Interface.

The acronym “TIA/EIA” means Telecommunications Industry Association/Electronic Industries Alliance.

The acronym “UART” means Universal Asynchronous Reciever Transmitter.

The acronym “VDC” means Voltage Direct Current.

The acronym “Y/C” means Luma/Chroma.

The acronym “YPbPr” means Green Blue Red.

The electronic hardware and software designs contain “hooks” that allow for the expansion of current functionality and the addition of new functionality without significant design/engineering effort. This allows customization of the MDP to meet the needs of multiple applications while maintaining a low cost.

The MDP is a display platform that is adaptable to a wide variety of communications interfaces, display sizes, form factors, and applications. The MDP is ruggedized and contains Built-In Test (BIT) capability suitable for use in military and other high reliability applications.

The MDP's initial configuration (known as the core configuration) is a 3ATI form factor display module 102 suitable for military avionics.

The embodiments of the invention comprise: 1) expansion achieved via common interface bus; 2) additional communication interfaces such as MIL-STD-1553, Ethernet, ARINC 429; 3) additional analog/digital I/O channels; 4) custom processing including DSP, video, audio; 5) streaming audio and video; 6) alternate display resolutions and interfaces including composite, component, and s-video.

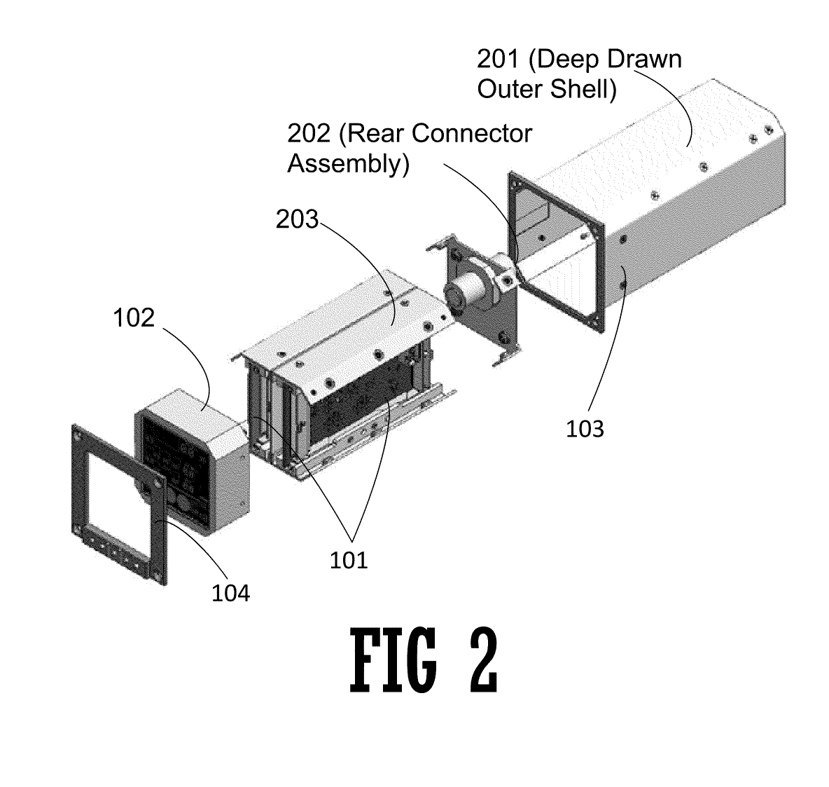

The embodiments comprise an aluminum structure 201 with an outer shell of deep-drawn aluminum with wall thickness of 0.035-0.050 inches to fit 3ATI envelope (IAW ARINC Spec 408A). The internal structure of the embodiments include: a display module 102, a control bezel 104, an I-beam structure 203 for mounting circuit boards, two (2) electronic circuit cards 101, and a connector for external signal I/O (MIL-DTL-38999). The internal structure will provide vibration and shock resistance while allowing easy assembly and maintenance. FIG. 2 illustrates the components of the MDP and the physical relationships between them.

The aluminum structure 203, the rear connector assembly 202, and the I-beam structure 201 provide the structural support to make the MDP extremely rugged. The rear connector assembly 202 and the I-beam structure 201 provide a means to isolate the electronic components from undue stress from the surroundings and channel stresses away from the electronic components. Further, the I-beam structure 201 is in mechanical contact with the electronic components and the aluminum structure 203 thereby providing a heat transfer pathway to channel excess heat from the electronic components to the surroundings.

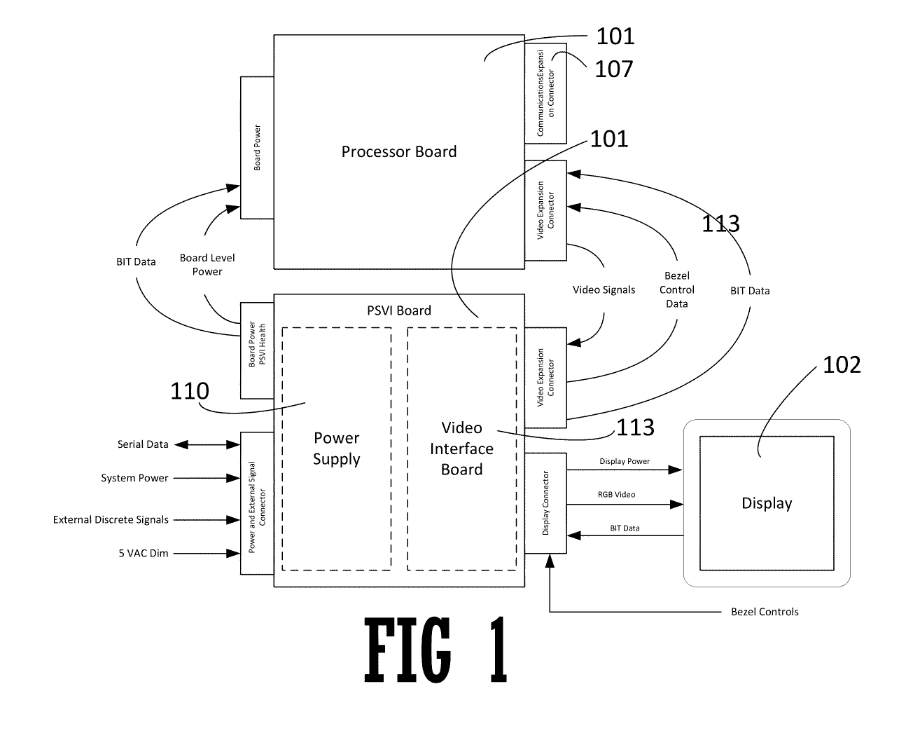

The MDP is modular, expandable, and ruggedized. The MDP is comprised of five main functional groups: 1) a low voltage power supply (LVPS) 110; 2) an expansion daughter card 111; 3) a processor board 112; 4) a video and display interface 113; and 5) an optical display assembly (ODA). FIG. 1 illustrates how these functional groups are allocated between the different embodiments of the MDP. The MDP utilizes a common bus architecture for linking these functional groups and for expandability. The architecture is adaptable to other form factors beyond 3-ATI. Components are selected based on guidance from MIL-HDBK-5400 whenever possible to ensure product reliability.

The optical display assembly (ODA) is a self-contained COTS 3-ATI display module 102. The electrical interfaces required to operate the ODA are contained on a video and display interface 113 and are considered part of the core configuration. The ODA is capable of displaying symbols, images, motion video, and alphanumeric characters to the operator. The ODA accepts one or more of the following standard video formats: analog (NTSC/PAL, S-Video, RGB, YPbPr) and digital (8-bit BT.656, Y/C, up to 24-bit RGB). The ODA provides native Built-In-Test (BIT) capability. The ODA is also capable of displaying a picture within a picture (PIP). This PIP capability provides the option of showing a split screen for additional data display or showing a live screen displayed simultaneously with at static image showing relevant data.

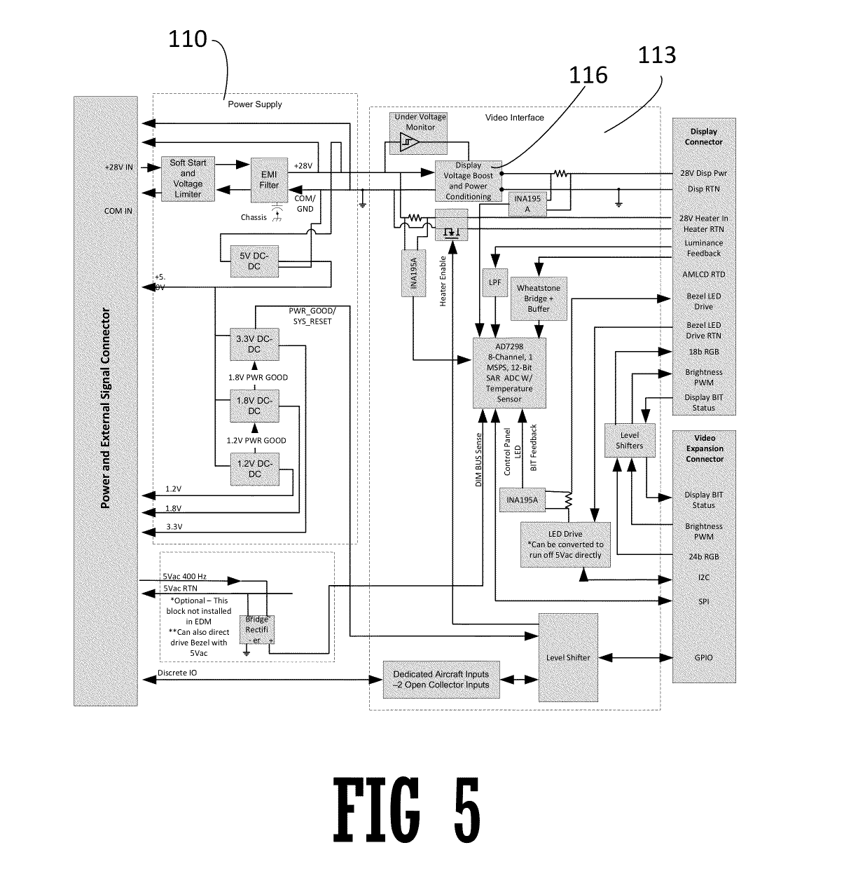

As shown in FIG. 5, the LVPS provides stepped-down, regulated voltages for use by the other circuit cards: 5V, 3.3V, 1.8V and 1.2V supply voltages. The LVPS provides a filtered 28V supply for the ODA and application-specific expansion daughter card(s) 111 on the expansion bus. The LVPS also provides electro-magnetic interference (EMI) filters to maintain compliance with MIL-STD-461. The system input impedance is controlled to ensure stability on the power bus. The LVPS operates when powered from a 28 VDC battery bus as described in MIL-STD-704. The LVPS provides Go/No-Go BIT indicators to the processor board 112 as a high level BIT check.

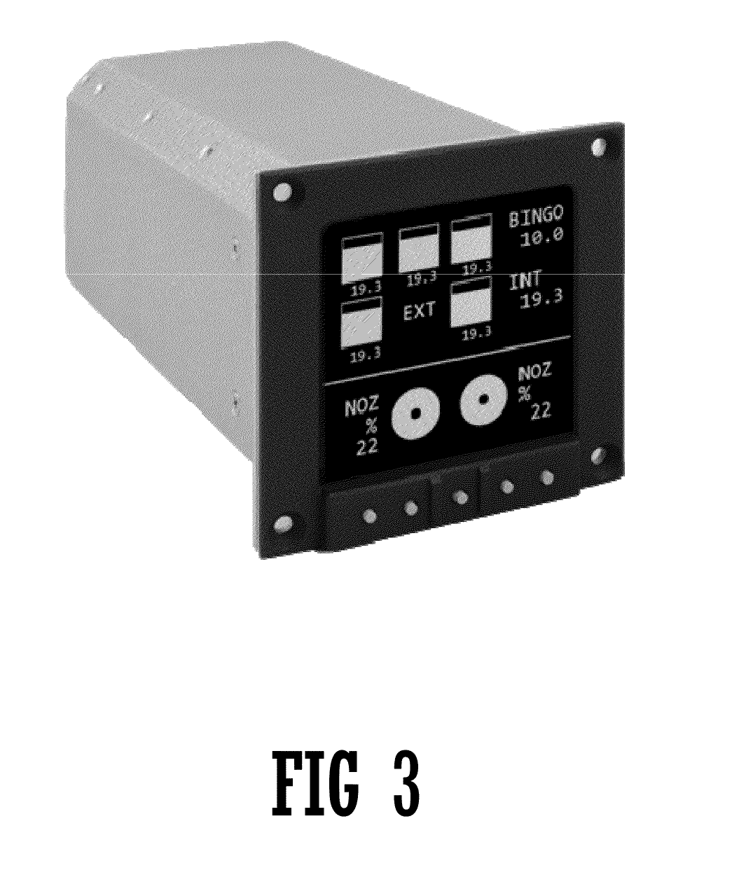

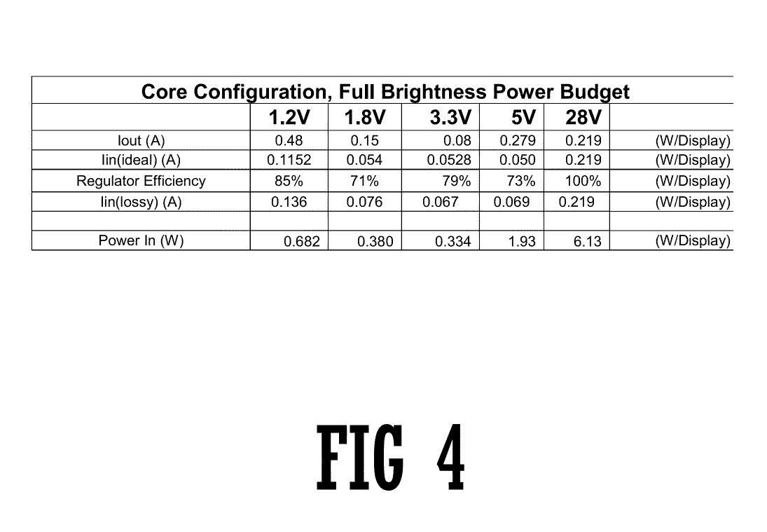

The power budget for the core configuration is provided in FIG. 4. The power budget is based upon parts used in the prototype pictured in FIG. 3. The power budget includes the ODA but not the the ODA heater.

The LVPS utilizes Texas Instruments (TI) TPS54310-EP step-down convertors for the 3.3V, 1.8V, and 1.2V low voltage supplies and a TI TPS40200-EP step-down convertor for the 5V low voltage supply. A TI TPS 402210-Q1 Boot Regulator is used for ODA power in low voltage conditions.

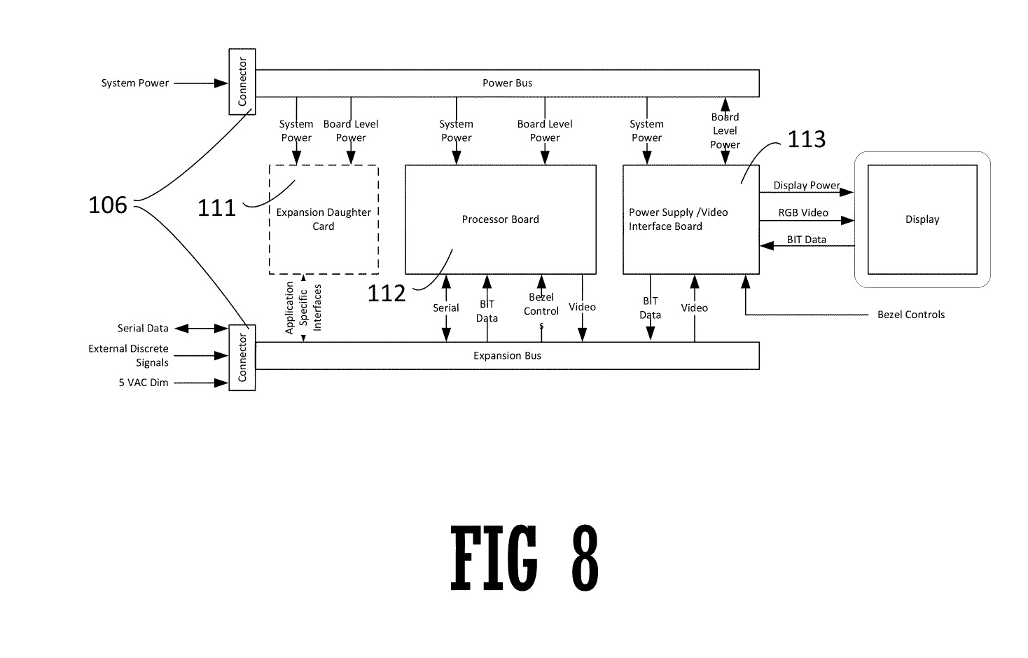

Expansion cards extend the functional capability of the MDP by allowing additional hardware functionality to be added easily without a complete redesign. Expansion cards are not required for the core configuration. Expansion cards use the same form factor CCA as core configuration CCAs. Expansion cards interface with core configuration CCAs by way of the expansion connector 107 and bus. FIG. 8 illustrates the concept of expansion using application specific expansion daughter card 111 to provide additional hardware capability to the MDP. The expansion bus contains several of the most common serial and parallel component interfaces in use today, including, but not limited to, Serial Peripheral Interface (SPI), Inter-Integrated Circuit (I²C), Universal Asynchronous Receiver/Transmitter (UART), and 16-Bit Parallel which enables the common core processor to communicate with any expansion card(s). Expansion cards enable the MDP to add additional capability to the core processor, allowing the same basic processor to be reused in any number of configurations.

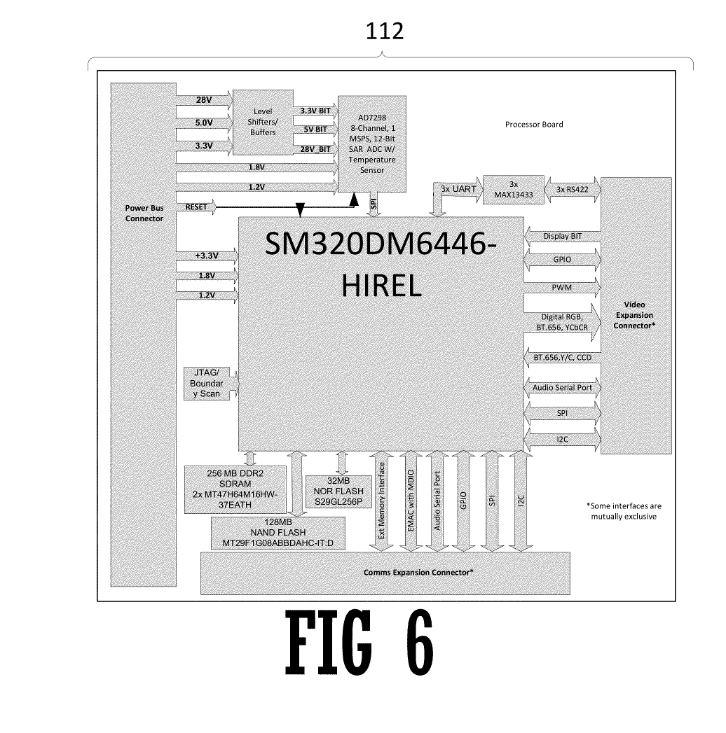

The processor CCA governs MDP behavior through software 108. FIG. 6 illustrates how the processor board 112 is interfaced to and monitors the behavior of the MDP. In the core configuration, the standard communications interface between the MDP and the platform it is installed on is TIA/EIA RS-422/485. The processor CCA is capable of receiving and processing the following standard video formats from either a CMOS/CCD or video decoder: digital BT.656, Y/C, or raw (Bayer Pattern Sensor Formats). The processor CCA uses the SM320DM6446-HIREL DaVinci™ processor as the core microcontroller/DSP platform.

The processor CCA contains at a minimum 128 MB DDR2 SDRAM, 16 MB NOR FLASH PROM, and 32 MB NAND FLASH PROM. NOR FLASH is used for bootloader and OFP non-volatile storage. NAND FLASH is used for fault and application specific non-volatile data storage. DDR2 SDRAM will be used for program data temporary storage. All RAM and ROM will interface to the microcontroller through the microcontroller's EMIF interface. BIT capability is incorporated into the processor CCA by means of both hardware and software 108. The processor CCA contains only necessary electronic hardware required to support microcontroller functionality. Application specific interfaces or hardware will be contained on a expansion daughter card 111.

The expansion bus provides a means for passing electrical signals between all CCAs in the stack. The expansion bus consists of, as a minimum, the following busses: EMAC with MDIO, Asynchronous EMIF, PWM,3x RS.422/485 Tx & Rx, SPI (1.8V Logic Level), I2C (3.3V Logic Level), GPIO (1.8V Logic Level I/O), 24.Bit Digital RGB, CMOS/CCD Interface, audio serial port, aircraft bus power, board level power. The expansion bus should contain at least one but no more than three separate connectors for both data and power. The expansion bus connectors leave pins unconnected and reserved for future use.

The video and display interface 113 contains the necessary electronics to interface the ODA and the control bezel 104 to the expansion bus. The video and display interface functionality is integrated into the same CCA as the LVPS. The video and display interface 113 contains a dimmable LED driver for controlling the control bezel 104 control panel backlight brightness. The video and display interface 113 provides BIT capability.

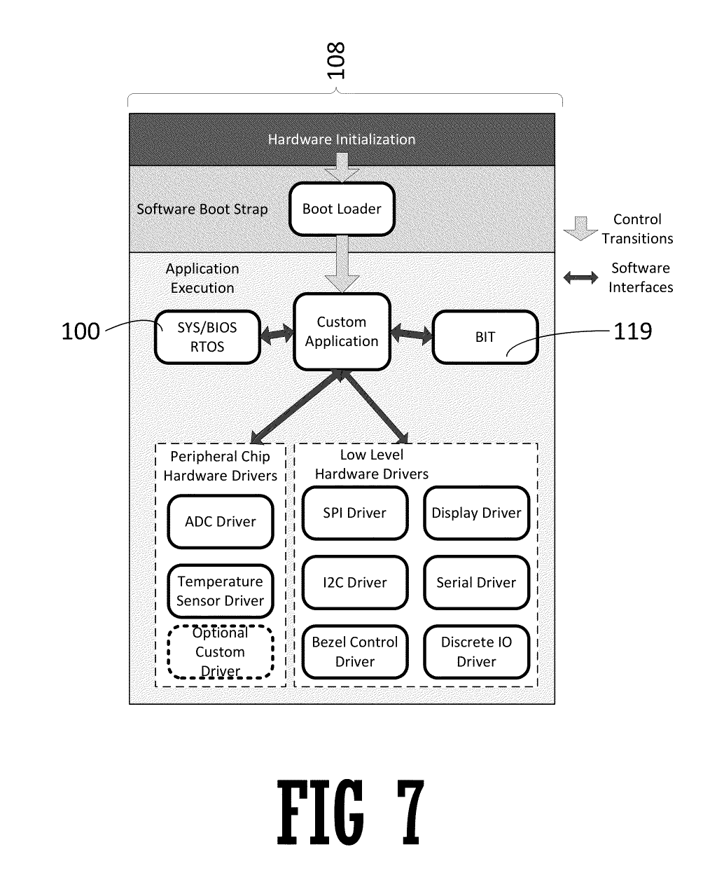

Major software 108 components developed for the core MDP configuration include: boot loader, operating system software 100, hardware drivers (UART Driver, Serial Peripheral Interface (SPI) Driver, Inter-Integrated Circuit (I2C) bus driver, ADC driver, temperature sensor driver, display driver, bezel control driver, discrete IO driver, BIT, and demonstration and self-test applications. FIG. 7 depicts the software components and their role in the stages of hardware initialization.

Boot loader responsibilities include: initializing the hardware necessary for booting the system, and locating and validating an application in nonvolatile memory. If no valid application is found the boot loader will wait for user input. The user may select to load a program over serial via a separate program that can be loaded into the MDP.

The operating system software 100 is comprised of TI's SYS/BIOS RTOS. The RTOS: schedules and prioritizes tasks, facilitates inter-task communications and synchronization, handles interrupts, and manages memory.

The hardware drivers comprise all the low level and hardware interfacing functions of the MDP. The hardware drivers have APIs available for higher level software such as BIT and user applications to use to access the hardware.

The BIT uses onboard hardware to monitor system status and health of the entire system. The BIT on board hardware is comprised of electrical current monitoring circuits, voltage monitoring circuits, temperature monitoring circuits, communications monitoring circuits, digital discrete signal test circuits, and analog to digital converters to convert analog monitoring signals into digital signals readable by the processor. The BIT uses onboard software to make BIT data available to application specific software that can be installed on the MDP.

The BIT onboard software is comprised of analog to digital converter monitoring software, voltage data conversion software, electrical current data conversion software, temperature data conversion software, and digital discrete signal test software.

BIT uses onboard hardware to evaluate system status and health. BIT also searches for hardware faults and exceptions.

The self-test application is a user level application that allows for manual and automated test of the MDP. The application uses the APIs of all other portions of the MDP software 108 to exercise all hardware functions of the MDP, including the display module 102. The application may be initiated through manual or programmatic control. Reporting is provided via the serial port or on the display module 102. The self-test application is designed to be used as functional test software 108 for the platform.

What is claimed is:

1. A low-cost display system and platform for hosting application-specific software comprised of
a. operating system software,
b. electronic circuit cards,
c. a display module,
d. a ruggedized housing,
e. a control bezel,
f. interface connectors that can be utilized as a platform for hosting application-specific software,
g. expansion connectors to support application specific interfaces,
h. expandable software that supports future applications.

2. The low-cost display system and platform for hosting application-specific software described in claim 1 comprised of application-specific software that causes the low-cost display system to display data that are specific to the weapons system, vehicle or other platform into which it is to be installed.

3. A low-cost display system and platform for hosting application-specific software comprised of
a. a low voltage power supply (LVPS);
b. an expansion daughter-card;
c. a processor;
d. a video and interface card; and
e. an optical display assembly (ODA).

4. The low-cost display system and platform for hosting application-specific software described in claim 3 wherein the optical display assembly (ODA) is a self-contained COTS 3-ATI display.

5. The low-cost display system and platform for hosting application-specific software described in claim 4 wherein the electrical interfaces required to operate the ODA are contained on a video and interface expansion card.

6. The low-cost display system and platform for hosting application-specific software described in claim 5 wherein the ODA displays symbols, images, and alphanumeric characters to the operator.

7. The low-cost display system and platform for hosting application-specific software described in claim 6 wherein the ODA accepts one or more of the following standard video formats: analog (NTSC/PAL, S-Video, RGB, YPbPr) and digital (8-bit BT.656, Y/C, up to 24-bit RGB).

8. The low-cost display system and platform for hosting application-specific software described in claim 7 wherein ODA provides native Built-In-Test (BIT) capability.

9. The low-cost display system and platform for hosting application-specific software described in claim 8 wherein the built-in-test capability is comprised of
a. electrical current monitoring circuits,
b. voltage monitoring circuits,
c. temperature monitoring circuits,
d. communications monitoring circuits,
e. digital discrete signal test circuits, and
f. analog to digital converters to convert analog monitoring signals into digital signals readable by the processor.

10. The low-cost display system and platform for hosting application-specific software described in claim 9 comprising onboard software to make BIT data available to application specific software that can be installed on the MDP wherein the onboard software is comprised of
a. analog to digital converter monitoring software,
b. voltage data conversion software,
c. electrical current data conversion software,
d. temperature data conversion software, and
e. digital discrete signal test software.

11. A low-cost display system and platform for hosting application-specific software comprised of
a. an aluminum structure with an outer shell of deep-drawn aluminum to fit an 3ATI envelope;
b. an I-beam structure; and
c. a rear connector assembly.

12. The low-cost display system and platform for hosting application-specific software described in claim 9 comprised of the I-beam structure which provide the structural support and heat transfer pathway to channel excess heat from the electronic components to the surroundings.
